(19) United States
(12) Patent Application Publication
(10) Pub. No.: US 2012/0287444 A1
(43) Pub. Date: Nov. 15, 2012

(54) IMAGE FORMING APPARATUS, CONTROL METHOD THEREOF, AND STORAGE MEDIUM

(75) Inventor: Tomoaki Osada, Yokohama-shi (JP)

(73) Assignee: CANON KABUSHIKI KAISHA, Tokyo (JP)

(21) Appl. No.: 13/459,526

(22) Filed: Apr. 30, 2012

(30) Foreign Application Priority Data
May 9, 2011 (JP) 2011-104053

(51) Int. Cl. G06K 15/02; H04N 1/04

(52) U.S. Cl. 358/1.2

(57) ABSTRACT

A document image is read at as high resolution as possible if printing is being executed. A control method for controlling an image forming apparatus includes reading a document image conveyed by a document feeding unit with a reading unit, printing the read document image on a sheet with a printing unit, and performing control so that, when the printing unit is not executing printing, the document image is read by the reading unit at a first resolution, and when the printing unit is executing printing, the document image is read by the reading unit at a second resolution that is higher than the first resolution.

### BACKGROUND OF THE INVENTION

1. Field of the Invention

The present invention relates to an image forming apparatus, a control method for an image forming apparatus, and a storage medium.

2. Description of the Related Art

Conventionally, in an image forming apparatus, a scanner reading speed and image quality, and a printer printing speed and image quality have typically been the same. For example, if the scanner is capable of reading 30 pages/minute at 600 dpi, the printer can also print 30 pages/minute at 600 dpi.

Further, in consideration of the use of a scanner by itself (e.g., FAX transmission and E-mail transmission of a read image), there are also image forming apparatuses that can read at a high resolution.

An example of such an image forming apparatus is an image forming apparatus that can read a document at 600 dpi as its scanner capability, read at 600 dpi when reading a document placed on a platen, and when reading a document conveyed by an automatic document feeder (hereinafter, “ADF”), lower the resolution to 300 dpi.

The reason for lowering the resolution when reading a document conveyed by an ADF is that if reading from the ADF is performed at 600 dpi, only 20 pages can be read per minute, so that the printer capability of 30 pages per minute cannot be fully utilized.

Japanese Patent Application Laid-Open No. 8-223336 discusses a technology relating to such an image forming apparatus, in which an operation mode is automatically determined based on the size of a scan document and the size of the printing paper.

Conventional image forming apparatuses read document images by limiting the resolution to a uniform level (e.g., an image forming apparatus capable of reading at 600 dpi lowers the resolution to 300 dpi). A sufficient effort for increasing the reading resolution is not performed.

For example, since an image forming apparatus cannot immediately print a read document image when it is executing another job, the document reading speed does not affect the printing speed even if it is slow. However, even in such a case, a conventional image forming apparatus lowers the resolution and reads the document image at 300 dpi.

Therefore, image forming apparatuses have not been sufficiently designed to utilize the resolution (e.g., 600 dpi) that its image reading unit is originally capable of when executing copying.

### SUMMARY OF THE INVENTION

According to an aspect of the present invention, an image forming apparatus includes a reading unit configured to read a document image conveyed by a document feeding unit, a printing unit configured to print the document image read by the reading unit on a sheet, and a control unit configured to perform control so that, when the printing unit is not executing printing, the document image is read by the reading unit at a first resolution, and when the printing unit is executing printing, the document image is read by the reading unit at a second resolution that is higher than the first resolution.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a cross-sectional view illustrating a configuration of an image forming apparatus according to an exemplary embodiment of the present invention.

FIG. 2 is a block diagram illustrating a configuration of an image forming apparatus according to an exemplary embodiment of the present invention.

FIG. 3 is a flowchart illustrating a control method of an image forming apparatus.

FIG. 4 illustrates an example of a UI screen that is displayed on an operation unit illustrated in FIG. 1.

FIG. 5 illustrates an example of a UI screen that is displayed on an operation unit illustrated in FIG. 1.

FIG. 6 is a flowchart illustrating a control method of an image forming apparatus.

FIG. 7 is a flowchart illustrating a control method of an image forming apparatus.

FIG. 8 is a plan view illustrating a hard key configuration of the operation unit illustrated in FIG. 2.

### DESCRIPTION OF THE EMBODIMENTS

Various exemplary embodiments, features, and aspects of the invention will be described in detail below with reference to the drawings.

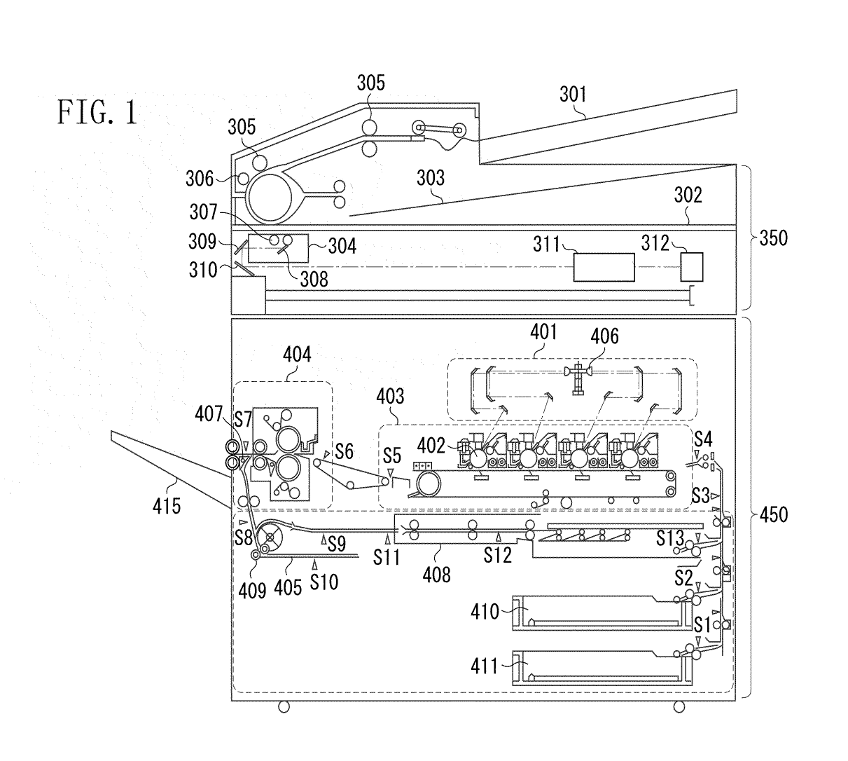

FIG. 1 is a cross-sectional view illustrating a configuration of an image forming apparatus according to an exemplary embodiment of the present invention. In the present exemplary embodiment, a multifunction peripheral (MFP) having a plurality of functions, such as a scanning function, a print function, and a data transmission function, will be described as an example.

As illustrated in FIG. 1, the MFP has a scanner unit 350 and a printer unit 450. The scanner unit 350 has an automatic document feeder (ADF) 301. The scanner unit 350 individually separates the documents stacked in the ADF 301 based on their stacked order, and conveys the documents to a reading position. Then, the scanner unit 350 scans the documents that have been conveyed to the reading position, and discharges the scanned documents onto a discharge tray 303.

The documents stacked on the ADF 301 are passed through a document skimming-through reading position at a constant speed by a conveyance roller 305 that is driven by a (not illustrated) stepping motor. In this case, an optical unit 304 moves to the document skimming-through reading position, and irradiates the documents conveyed at a constant speed with a light source 307.

Reflected light from a document is guided via a plurality of mirrors 308, 309, and 310, and a lens 311 to a charged-couple device image sensor (hereinafter, “CCD”) 312 that has a color separation filter. Consequently, an image of the scanned document is read by the CCD 312. Image data in each color (R, G, and B) is generated by separating and reading the colors with the CCD 312. This image data is then transferred to a memory unit for storing or printing.

The printer unit 450 has four developing units for forming an image with cyan (C), magenta (M), yellow (Y), and black (K) toners to form color and monochrome images.

The printer unit 450 has a laser exposure unit 401, a rotating polygonal mirror (polygon mirror) 406, a photosensitive drum 402, an image forming unit 403, a fixing unit 404, a reversing path 405, a flapper 407, and a two-sided conveyance path 408. The reversing path 405 includes a reversing roller 409. Further, the printer unit 450 has a paper feed cassette 410, a paper feed cassette 411, and a discharge tray 415.

The laser exposure unit 401 emits a light beam, such as laser light modulated based on the image data, onto the rotating polygonal mirror (polygon mirror) 406 rotating at a constant angular velocity, to irradiate the photosensitive drum 402 with the light beam as reflected scanning light.

The image forming unit 403 is realized by including four developing units (developing stations), each of which executes a series of electrophotographic processes. More specifically, each developing unit drives and rotates a photosensitive drum 402, charges the photosensitive drum using a charger, and develops a latent image formed on the photosensitive drum 402 by the laser exposure unit 401 with a toner. Then, the developing unit transfers the toner image onto a sheet, and collects the small amount of toner which has not been transferred and remains on the photosensitive drum 402.

The four developing units are arranged in order of cyan (C), magenta (M), yellow (Y), and black (K). After a predetermined period has elapsed from the start of image formation at the cyan developing unit, image forming is successively executed by the magenta, yellow, and black developing units. Based on this timing control, a color image free from color misregistration is transferred onto the sheet.

The fixing unit 404 is configured from a combination of rollers and belts. The fixing unit 404 incorporates a heat source such as a halogen heater, and fuses and fixes by heat and pressure the toner on the sheet on which the toner image has been transferred by the image forming unit 403. As the fixing method, an on-demand fixing process may be employed. The paper feed cassettes 410 and 411 respectively hold the sheets to be used for printing.

An image forming apparatus 100 feeds a sheet from either of the paper feed cassettes 410 or 411, and transfers the image formed by the image forming unit 403 onto the fed sheet. Then, the image forming apparatus 100 fixes the transferred image on the sheet with the fixing unit 404.

Next, if the face on which the image is formed of the sheet to be discharged is facing downwards (when performing face down discharge), the image forming apparatus 100 guides the sheet with the flapper 407 to the reversing path 405, and discharges the reversed sheet onto the discharge tray 415. On the other hand, if the face on which the image is formed of the sheet to be discharged is facing upwards (when performing face up discharge), the image forming apparatus 100 discharges the sheet onto the discharge tray 415 without guiding it with the flapper 407 to the reversing path 405.

Further, when printing an image on each side of the sheet, the image forming apparatus 100 guides the sheet to the reversing path 405 with the flapper 407, pinches the trailing edge of the sheet with the reversing roller 409, and then guides the sheet to the two-sided conveyance path 408. The sheet that has been guided to the two-sided conveyance path 408 is again conveyed to the image forming unit 403, and an image is printed on the back face of the sheet by the image forming unit 403.

Then, the sheet, which has an image formed on its rear face, is discharged onto the discharge tray 415. Based on the above-described processes, the image forming apparatus 100 executes print processing for printing an image on a sheet.

In FIG. 1, the image forming apparatus also has sheet detection sensors S1 to S3 that are provided on the illustrated conveyance path. Detection information from these sensors S1 to S3 is notified to a below-described MFP control unit 209.

Although an example has been described above in which two paper feed cassettes are used, the number of paper feed cassettes may be one, or three or more. Further, in the present exemplary embodiment, although an MFP is described as the image forming apparatus, examples of the image forming apparatus are not limited to this. The image forming apparatus may be, for example, a copying machine.

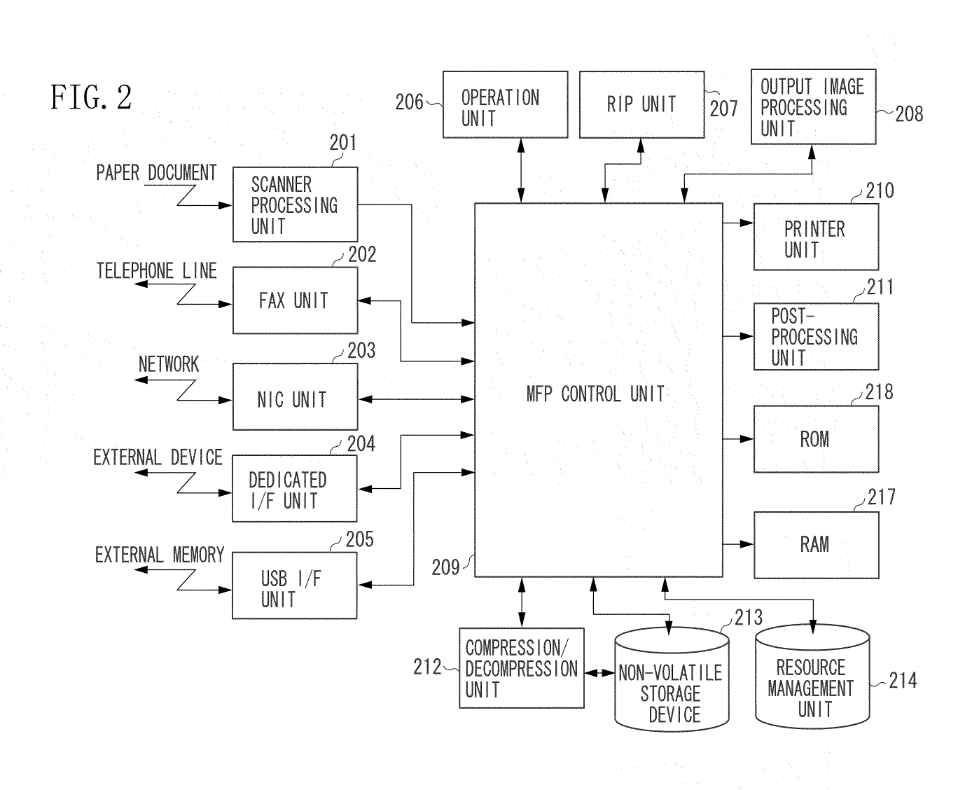

FIG. 2 is a block diagram illustrating a configuration of an image forming apparatus according to the present exemplary embodiment.

In FIG. 2, the MFP control unit 209 controls the MFP in an integrated manner by reading and executing programs stored on a read-only memory (ROM) 218 into a random access memory (RAM) 217. The ROM 218 stores various programs that are read by the MFP control unit 209. The RAM 217 functions as a work memory for the MFP control unit 209.

A scanner processing unit 201 performs predetermined image processing, such as shading correction processing, on an image of a paper document, for example, read by the scanner unit 350 illustrated in FIG. 1. A facsimile (FAX) unit 202 performs image transmission and reception utilizing a telephone line. A representative example of the FAX 202 is a facsimile machine. A network interface card (NIC) 203 transmits and receives image data and apparatus information to and from an external apparatus utilizing a network.

A dedicated interface (I/F) unit 204 exchanges information, such as image data, with an external apparatus. A universal serial bus (USB) I/F unit 205 transmits and receives image data, for example, with a USB device, represented by a USB memory (a type of removable medium). An operation unit 206, which includes a touch panel, displays a below-described user interface screen (UI screen).

A non-volatile storage device 213 is configured from a memory such as a hard disk capable of storing a plurality of image data. The MFP control unit 209 stores a plurality of types of image data in this hard disk, such as image data from the scanner processing unit 201 and image data from an external apparatus like a computer input via the NIC unit 203.

The MFP control unit 209 appropriately reads the image data stored in the non-volatile storage device 213, transfers the read image data to an output image processing unit 208, and executes image processing for printing by the output image processing unit 208. Further, based on an instruction from an operator, the MFP control unit 209 can transfer the image data read from the non-volatile storage device 213 to an external apparatus, such as a computer or another image forming apparatus.

When storing image data in the non-volatile storage device 213, the MFP control unit 209 compresses and stores the image data as required by using a compression/decompression unit 212. Conversely, when reading compressed stored image data, the MFP control unit 209 can decompress the image data into the original image data by using the compression/decompression unit 212.

Especially, some data that having been received via a network may have been compressed. Thus, such compressed data is decompressed (extracted) by the compression/decompression unit 212.

A resource management unit 214 stores various parameter tables that are commonly handled by the MFP, such as font, color profile, and gamma tables. The resource management unit 214 can call up these tables as required. Further, the resource management unit 214 can also store a new parameter table, and correct and update the tables.

When page description language (PDL) data has been received, the MFP control unit 209 performs raster image processor (RIP) processing on the PDL data with a RIP unit 207. Further, the MFP control unit 209 performs image processing for printing with the output image processing unit 208 as required on the image that was subjected to RIP processing.

The MFP control unit 209 can also store, as required, in the non-volatile storage device 213 intermediate data and print-ready data (bitmap data and compressed bit map data for printing) generated at this stage.

In addition, the MFP control unit 209 transmits the processed image data to a printer unit 210 that will perform image formation. The MFP control unit 209 controls the printer unit 210 so as to execute printing based on the transmitted image data, and convey the printed sheet to a post-processing unit 211.

The post-processing unit 211 directly receives the conveyed sheets printed by the image processing apparatus 210, and performs processing such as sorting of the received sheets and finishing processing such as stapling.

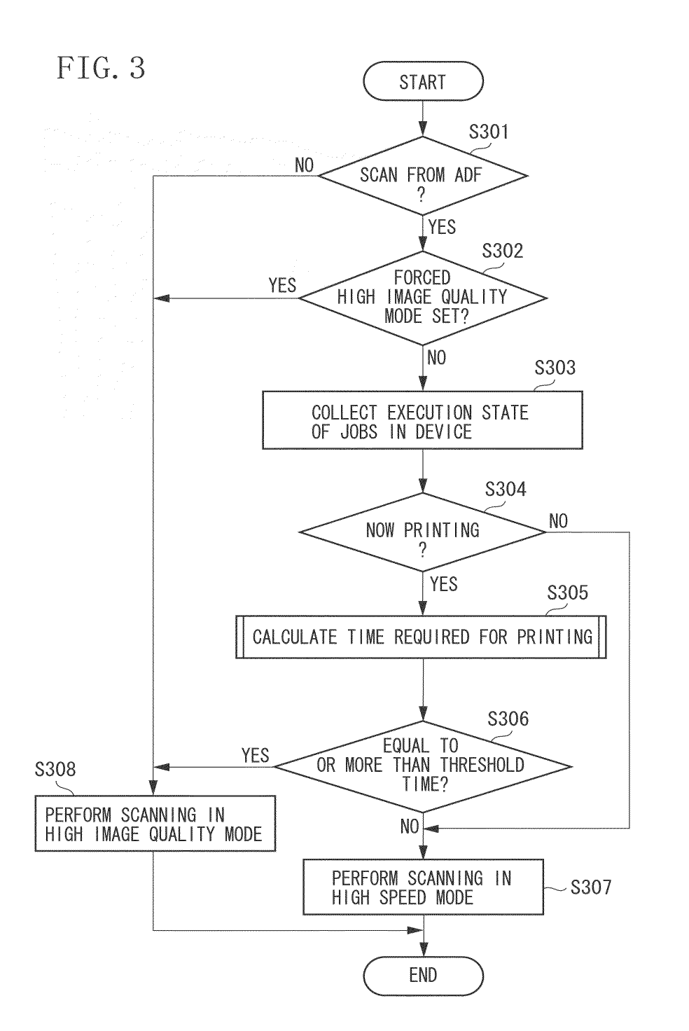

FIG. 3 is a flowchart illustrating a control method of the MFP according to the present exemplary embodiment.

The present exemplary embodiment is a processing example in which, when a copy job for printing an image of a document read by the scanner unit 350 is executed by the printer unit 450, the reading mode of the scanner unit 350 illustrated in FIG. 1 is automatically determined.

More specifically, the present exemplary embodiment is a processing example in which an image of a document is read at a first resolution when the MFP is not executing printing, and an image of a document is read at a second resolution (high image quality reading mode) that is a higher resolution than the first resolution when the MFP is executing printing.

The first resolution, which is called a high speed mode, is a reading mode for reading an image of a document at a first resolution of 300 dpi, for example. The second resolution, which is called a high image quality mode, is a reading mode for reading an image of a document at a second resolution of 600 dpi, for example.

Each step in the flowchart is realized by the MFP control unit 209 loading and executing a program read from the ROM 218, for example, into the RAM 217. The processing illustrated in this flowchart is started in response to reception of a copy job start instruction (or a document reading start instruction) via the operation unit 206.

First, in step S301, the MFP control unit 209 determines whether to read an image of a document placed in the ADF 301. This is performed by the MFP control unit 209 confirming the state of a document placement detection switch provided on a platen of the ADF 301.

If the MFP control unit 209 determines that a document is not placed on the ADF 301 platen (NO in step S301), the processing proceeds to step S308. In step S308, the MFP control unit 209 performs control so that the documents are read one by one via the platen (platen glass 302).

At this stage, the number of documents that can be read in response to one received reading start instruction via the operation unit 206, is one. Even if scanning is performed in high image quality mode, it affects little in reduction in speed. Consequently, the MFP control unit 209 scans an image of the one document that is to be read for the copy job for which an execution instruction has been received at the second resolution (scans in high image quality mode), and then finishes the processing of this flowchart.

On the other hand, in step S301, if the MFP control unit 209 determines that a document is placed on the ADF 301 platen (YES in step S301), the processing proceeds to step S302. In this case, the number of documents that is to be read in response to one reading start instruction received via the operation unit 206 may be a plurality of documents. Consequently, when scanning is performed in high image quality mode, the document image reading processing may take time, which can prevent the MFP printing speed from being accomplished.

For example, for an MFP having a scanner unit 350 that can read document images at 600 dpi, the MFP printing speed is 30 pages/minute, the document reading speed at 600 dpi using the ADF is 20 pages/minute, and the document reading speed at 300 dpi is 30 pages/minute.

In this case, when reading a document at 600 dpi using the ADF, the MFP's capability (printing speed) cannot be sufficiently utilized. However, if document images are uniformly read at 300 dpi using the ADF, a document image can never be read at 600 dpi using the ADF.

Therefore, in the present exemplary embodiment, the MFP performs control so that document images are read at 300 dpi when another job is not being printed, and read at 600 dpi when another job is being printed.

The reason for controlling in this manner is that when another job is being printed, a plurality of pages worth of read document images is temporarily accumulated in the non-volatile storage device 213 without copying being started immediately. Consequently, there is a low risk of a slowdown in printing due to the slowness of the reading speed.

Therefore, document images can be read at as high quality as possible while also utilizing the capability (printing speed) that the MFP has. When the processing proceeds from step S301 to step S302, the MFP control unit 209 determines whether a forced high image quality mode has been set in advance via the operation unit 206 by the user. This forced high image quality mode is a mode that is selected when the user wishes to obtain a high image quality output product without fail.

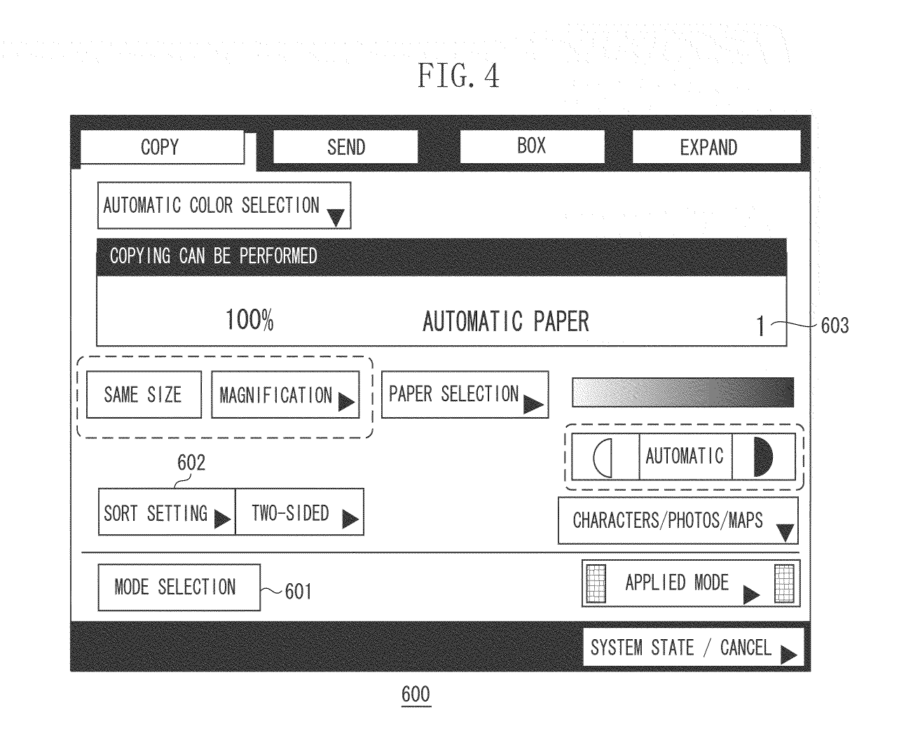

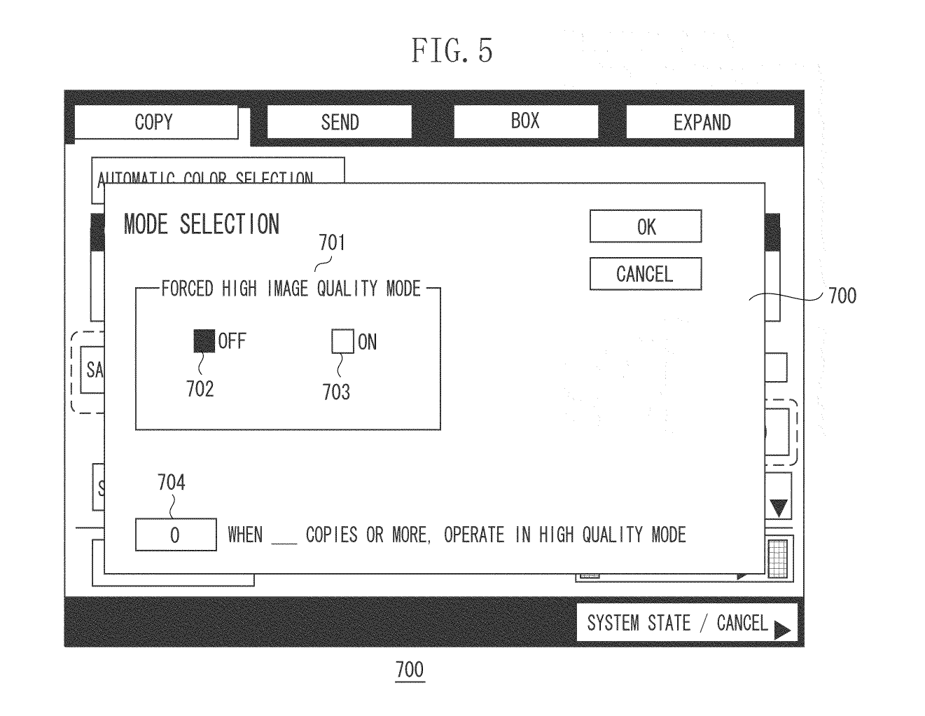

FIGS. 4 and 5 illustrate an example of a user interface screen that is displayed on the operation unit 206 illustrated in FIG. 1 before a copy start instruction is received.

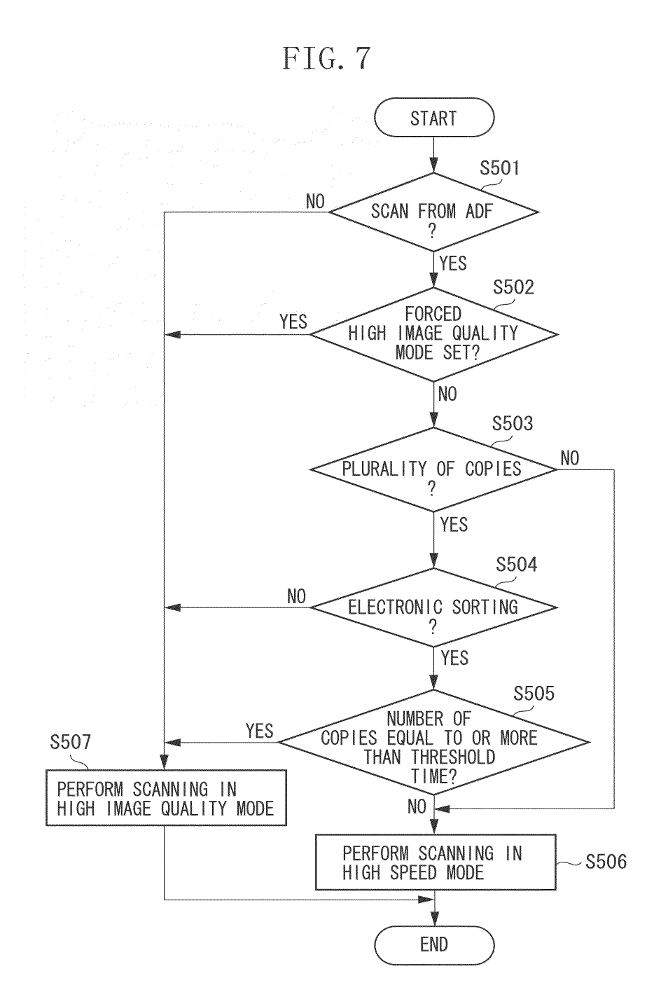

Forced high image quality mode is set by the user pressing a mode selection button 601 on the copy setting screen 600 illustrated in FIG. 4 that is displayed on the operation unit 206. When the mode selection button 601 is pressed, the MFP control unit 209 opens a mode selection dialog 700 illustrated in FIG. 7 on the operation unit 206.

The default value of a forced high image quality mode selection box is a state in which the off box 702 has been selected.

When the user checks an on box 703 in the checkbox, and presses the ON button, the MFP control unit 209 sets the forced high image quality mode, stores this setting in a status table in the non-volatile storage device 213, and closes the mode selection dialog 700.

On the other hand, if the cancel button is pressed, the MFP control unit 209 closes the mode selection dialog 700 without storing the contents set via the mode selection dialog 700 in the image processing unit 713. Concerning a number of copies threshold setting unit 704, this unit will be described below.

In step S302, if the MFP control unit 209 determines that the forced high image quality mode is set by referring to the status table stored in the non-volatile storage device 213 (YES in step S302), the processing proceeds to step S308.

In step S308, the MFP control unit 209 causes the scanner unit 350 to scan an image of one or a plurality of documents conveyed by the ADF at the second resolution (scan in high image quality mode) by executing the copy job for which an execution instruction has been received, and then finishes the processing of this flowchart.

On the other hand, if the MFP control unit 209 determines that the forced high image quality mode is not set (NO in step S302), the processing proceeds to step S303. In step S303, the MFP control unit 209 acquires information indicating the execution state of the job being executed by the MFP. The information indicating the execution state of the job is stored by the MFP control unit 209 as a job management list for each job type in the RAM 217.

When a job execution instruction is received, the MFP control unit 209 registers information about the job in the job management list, and executes the registered jobs in order of highest priority. Further, the MFP control unit 209 manages the status of each job (execution standby, currently being executed etc.) in the job management list.

Examples of the types of job registered in the job management list include a print job, a FAX reception job, a copy job, a data transmission job, and the like.

A print job is a job for performing printing with the printer unit 210 based on print data received from an external apparatus via the NIC unit 203.

A FAX reception job is a job for performing printing with the printer unit 210 based on image data received via the FAX unit 202.

A copy job is a job for printing an image of a document read by the scanner unit 350 on a sheet with the printer unit 210.

A data transmission job is a job for transmitting an image of a document read by the scanner unit 350 to an external apparatus via a network.

In step S304, the MFP control unit 209 determines whether there is a job currently being printed by searching the job management list for all job types that are stored in the RAM 217.

If the MFP control unit 209 determines that printing is not currently being performed (NO in step S304), the processing proceeds to step S307. In step S307, the MFP control unit 209 controls the scanner unit 350 so that a document image is scanned at the first resolution, which is lower than the second resolution.

This is because when printing is not being executed, since printing starts based on the storage of an image of a first page in the non-volatile storage device 213, there is a high likelihood of a slowdown in the printing due to the slowness of the reading speed.

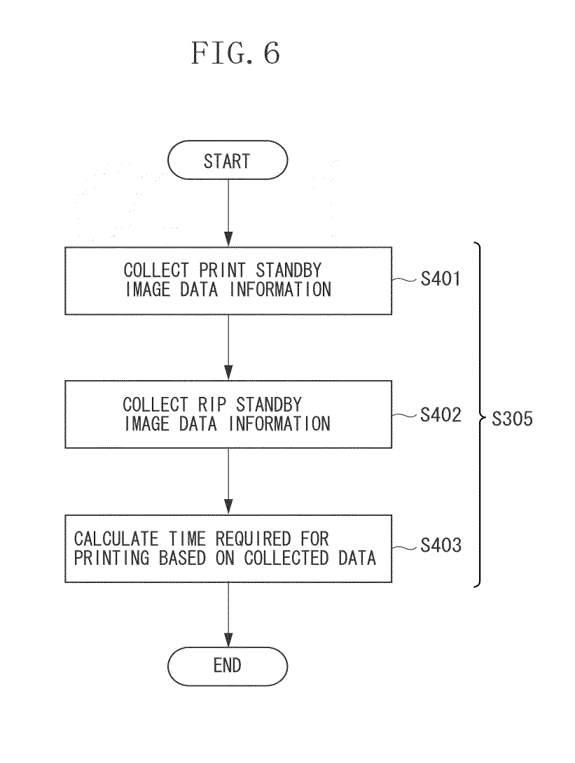

On the other hand, in step S304, if the MFP control unit 209 determines that printing is currently being executed (YES in step S304), the processing proceeds to step S305. In step S305, the MFP control unit 209 calculates the time required for the printing currently being performed. Step S305 is a sub-routine in which processing for calculating the time required for printing is performed. This processing will be described in more detail using the flowchart illustrated in FIG. 6.

FIG. 6 is a flowchart illustrating a control method of the MFP according to the present exemplary embodiment.

This example is an example of the processing for calculating the total time (processing time) that is required for printing the jobs that need to be printed which are present in the image forming apparatus. FIG. 6 illustrates the order of the processing performed in step S305 of FIG. 3 in detail. Each step in the flowchart is realized by the MFP control unit 209 loading and executing a control program read from the ROM 218, for example, into the RAM 217.

In step S401, the MFP control unit 209 collects information about the print standby image data managed in the non-volatile storage device 213. The image data for printing is image data that has undergone RIP rasterization by the RIP unit 207. This image data is rasterized in the non-volatile storage device 213, and deleted after printing has finished. In this step, the MFP control unit 209 collects information about, for example, the number of pages of image data, the size of each page, whether each page is color or monochrome, and the resolution of each page.

Next, in step S402, the MFP control unit 209 collects information about the RIP standby image data. This RIP standby image data is PDL data that is yet to undergo RIP rasterization by the RIP unit 207, and is stored in the non-volatile storage device 213.

In step S402, similar to step S401, the MFP control unit 209 collects information about, for example, the number of pages of image data, the size of each page, whether each page is color or monochrome, and the resolution of each page. However, based on the type of the PDL data, it may be impossible to collect detailed information before RIP rasterization.

In such a case, the total number of pages is calculated based on the size of typical single page based on the size of the PDL data. This is because the data is for calculating a predicted printing time, so that a slight error is not a problem.

In step S403, the MFP control unit 209 calculates the time required for printing based on the information collected in steps S401 and S402. Specifically, the MFP control unit 209 can calculate the time required for printing by registering in advance in the non-volatile storage device 213 the time required to print one page for each image size, color/monochrome, and resolution.

Next, returning to FIG. 3, in step S306, the MFP control unit 209 compares the required time calculated in step S305 with a threshold set in the system, and determines whether the required time is equal to or more than the threshold set in the system.

Based on the comparison, if the MFP control unit 209 determines that the time required for printing is equal to or more than the threshold (YES in step S306), the processing proceeds to step S308. Then, in step S308, the MFP control unit 209 controls the scanner unit 350 so that it scans an image of one or a plurality of documents to be read for the copy job for which an execution instruction has been received at the second resolution (controls so as to scan in high image quality mode), and then finishes the processing of this flowchart.

On the other hand, in step S306, based on the comparison, if the MFP control unit 209 determines that the time required for printing is less than the threshold (NO in step S306), the processing proceeds to step S307. Then, in step S307, the MFP control unit 209 controls the scanner unit 350 so that it scans an image of one or a plurality of documents to be read for the copy job for which an execution instruction has been received at the first resolution (scans in high speed mode), and then finishes the processing of this flowchart.

Thus, the document images read in step S308 or S309 are stored in the non-volatile storage device 213. Further, when information about the copy job is registered in the job management list, and a job's turn to be executed comes up, the MFP control unit 209 executes printing with the printer unit 210 based on the images stored in the non-volatile storage device 213.

Consequently, a slowdown in printing due to the long reading time can be prevented. Further, when printing is being performed, the document images can be read at the highest possible resolution.

In the present exemplary embodiment, a case has been described in which when the MFP control unit 209 determines in step S304 that printing is currently being executed, and the processing proceeds to step S305. However, the present invention is not limited to this.

For example, when the MFP control unit 209 determines in step S304 that printing is currently being executed, the processing can skip steps S305 and S306 and proceed directly to step S308, and when the MFP control unit 209 determines that printing is not currently being executed, the processing may proceed to step S307.

In a second exemplary embodiment, an example is described in which the MFP control unit 209 determines whether to execute scanning in a high image quality mode or in a high speed mode based on a different method from that of the first exemplary embodiment.

FIG. 7 is a flowchart illustrating a control method of an image forming apparatus according to the present exemplary embodiment. The present exemplary embodiment is an example in which the MFP control unit 209 determines whether to execute scanning in a high image quality mode or in a high speed mode based on a setting value of the copy job to be executed.

Each step in the flowchart is realized by the MFP control unit 209 loading and executing a control program read from the ROM 218 into the RAM 217. A detailed description of the parts of the present exemplary embodiment that are the same as those of the first exemplary embodiment will be omitted. The differences with the first exemplary embodiment reside in steps S503 to S505.

In step S502, if the MFP control unit 209 determines that a forced high image quality mode has not been set (NO in step S502), the processing proceeds to step S503. In step S503, the MFP control unit 209 determines whether a plurality of copies is set in the display screen illustrated in FIG. 4 displayed on the operation unit 206.

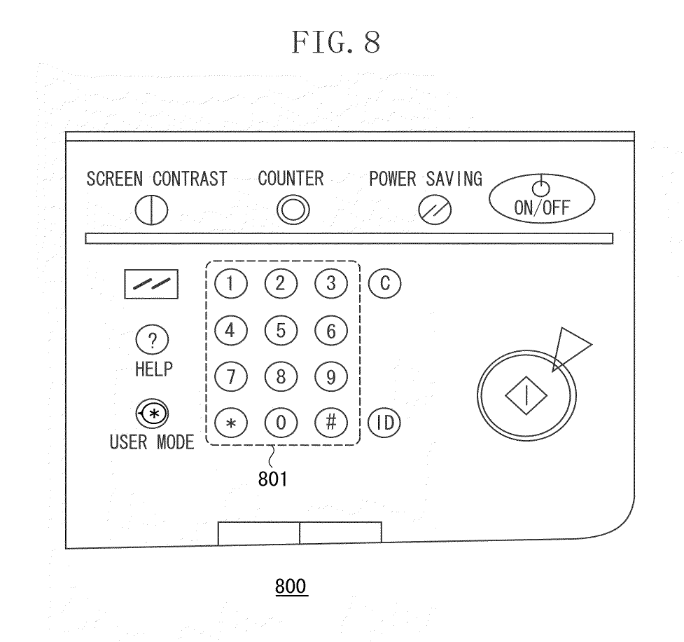

The number of copies setting is displayed on a page number display 603 of the copy setting screen 600 when the user uses numerical keypad 801 of a hard key 800 on the operation unit 206 illustrated in FIG. 8, in a state in which the display screen illustrated in FIG. 4 is displayed.

If the MFP control unit 209 determines that a setting to print a plurality of copies is not set (NO in step S503), the processing proceeds to step S506. In step S506, the control unit 209 controls the scanner unit 350 so as to scan an image of the document at the first resolution (scan in the high speed mode), and then finishes the processing of this flowchart.

On the other hand, in step S503, if the MFP control unit 209 determines that a setting to print a plurality of copies is set (YES in step S503), the processing proceeds to step S504. In step S504, the control unit 209 determines whether the images of the read documents are set to be electronically sorted.

If the MFP control unit 209 determines that electronic sorting is set (YES in step S504), the MFP reads the plurality of documents, and temporarily stores the read document images in the non-volatile storage device 213. Then, the MFP prints one copy of the stored document images in the page order. Printing of stored one copy of the document images is completed, then printing the next copy of document images in order.

The sort mode setting is set by the user pressing a sort mode selection button 602 on the copy setting screen 600 illustrated in FIG. 4.

If the MFP control unit 209 determines that electronic sorting is not set (NO in step S504), since printing is executed in a non-sorting mode, the processing proceeds to step S507. In step S507, the MFP control unit 209 causes the scanner unit 350 to scan an image of one or a plurality of documents to be read for the copy job for which an execution instruction has been received at the second resolution (scan in high image quality mode), and then finishes the processing of this flowchart.

Non-sorting mode is a mode in which an image of one document is scanned, and a specified number of copies of the scanned document image is consecutively printed.

In this case, since a plurality of copies is printed based on the scanning of one page, there is a low risk of a slowdown in the printing speed due to scanning slowness. Consequently, the image of the document is read at the second resolution, which is higher than the first resolution.

On the other hand, in step S504, if the MFP control unit 209 determines that electronic sorting is set (YES in step S504), the processing proceeds to step S505. In step S505, the MFP control unit 209 determines whether a judgment copy number is equal to or more than a threshold.

The judgment copy number threshold setting is set via the mode selection dialog 700 that is started up when the mode selection button 601 on the copy setting screen 600 displayed by the MFP control unit 209 on the operation unit 206 is pressed.

The user inputs a number via the numerical key pad 801 illustrated in FIG. 8 in a number of copies threshold setting unit 704. The MFP control unit 209 stores the input value as a judgment copy number in the non-volatile storage device 213.

In step S505, if the MFP control unit 209 determines that the set number of copies for electronic sorting is equal to or more than the threshold (YES in step S505), the processing proceeds to step S507. In step S507, the MFP control unit 209 causes the scanner unit 350 to scan an image of one or a plurality of documents to be read for the copy job for which an execution instruction has been received at the second resolution (scan in high image quality mode), and then finishes the processing of this flowchart.

When printing a predetermined number of copies or more in electronic sorting mode, high-speed printing can be performed at least after the second copy because a scanned image for the first copy is stored in the non-volatile storage device 213.

Consequently, when printing a predetermined number of copies or more, the user can obtain a print product that has been read at a high resolution and printed at a high resolution even if the scan for the first copy is slow.

Further, the processing may be performed so that, when “0” is input as the judgment copy number, if the MFP control unit 209 determines that the electronic sorting mode is set, the processing proceeds directly to step S506 without performing the judgment of step S505.

On the other hand, in step S505, if the MFP control unit 209 determines that the set number of copies is less than the threshold or that the threshold is zero (NO in step S505), the processing proceeds to step S506. In step S506, the control unit 209 causes the scanner unit 350 to scan an image of the document at the first resolution (scan in high speed mode), and then finishes the processing of this flowchart.

Thus, the document images read in step S506 or S507 are stored in the non-volatile storage device 213. Further, when information about the copy job is registered in the job management list, and a job's turn to be executed comes up, the MFP control unit 209 executes printing with the printer unit 210 based on the images stored in the non-volatile storage device 213.

By performing control in the above manner, the operation mode can be automatically determined based on the setting value of the copy job.

Further, although the method for switching scan operation modes when executing a copy job based on the printing state in the device and the method for automatically determining the operation mode based on the copy job setting value were described as separated flowcharts, these processes may also be performed simultaneously.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-104053 filed May 9, 2011, which is hereby incorporated by reference herein in its entirety.

What is claimed is:

1. An image forming apparatus comprising:
a reading unit configured to read a document image conveyed by a document feeding unit;
a printing unit configured to print the document image read by the reading unit on a sheet; and
a control unit configured to perform control so that, when the printing unit is not executing printing, the document image is read by the reading unit at a first resolution, and in a case where the printing unit is executing printing, the document image is read by the reading unit at a second resolution that is higher than the first resolution.

2. The image forming apparatus according to claim 1, wherein the reading unit is capable of reading a document image conveyed by the document feeding unit or a document image placed on a platen, and
wherein the control unit is configured to perform control so that, when reading the document image placed on the platen, the document image placed on the platen is read at the first resolution regardless of whether the printing unit is executing printing or not.

3. The image forming apparatus according to claim 1, further comprising:
a calculating unit configured to calculate a processing time required for printing with the printing unit,
wherein the control unit is configured to perform control so that, when the printing unit is executing printing, and the processing time calculated by the calculating unit exceeds a predetermined time, the document image is read by the reading unit at a second resolution that is higher than the first resolution.

4. The image forming apparatus according to claim 1, further comprising:
a determining unit configured to determine whether a sort mode is set for sheets printed by the printing unit; and
a judging unit configured to judge whether it is set to print a plurality of copies of a sheet printed by the printing unit,
wherein the control unit is configured to perform control so that, when it is determined by the determining unit that the sort mode is not set, and judged by the judging unit that it is set to print a plurality of copies of a sheet printed by the printing unit, the document image is read by the reading unit at a second resolution that is higher than the first resolution.

5. A control method for controlling an image forming apparatus, comprising:
reading a document image conveyed by a document feeding unit with a reading unit;
printing the read document image on a sheet with a printing unit; and
performing control so that, when the printing unit is not executing printing, the document image is read by the reading unit at a first resolution, and when the printing unit is executing printing, the document image is read by the reading unit at a second resolution that is higher than the first resolution.

6. A non-transitory computer readable storage medium for storing a computer program for controlling an image forming apparatus, the computer program comprising:
a code to read a document image conveyed by a document feeding unit with a reading unit;
a code to print the read document image on a sheet with a printing unit; and
a code to perform control so that, when the printing unit is not executing printing, the document image is read by the reading unit at a first resolution, and when the printing unit is executing printing, the document image is read by the reading unit at a second resolution that is higher than the first resolution.
